(19) United States
(12) Patent Application Publication
(10) Pub. No.: US 2008/0287614 A1
(43) Pub. Date: Nov. 20, 2008

(54) Polypropylene-Based Polymer Blend of Enhanced Melt Strength

(75) Inventor: Subir K. Dey, Florence, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/748,589

(22) Filed: May 15, 2007

(51) Int. Cl. C08L 23/06; C08L 23/12

(52) U.S. Cl. 525/92 R; 525/210

(57) ABSTRACT

The melt strength of polypropylene is enhanced by blending a cyclo-olefin copolymer into the polypropylene. The cyclo-olefin copolymer comprises an amorphous random copolymer of ethylene and norbornene, the cyclo-olefin copolymer comprising at least about 60 wt. % of norbornene. As a result of the high norbornene content of the COC, the glass transition temperature of the COC is relatively high. In preferred embodiments, the norbornene content ranges from about 60 wt. % to about 85 wt. %, and the glass transition temperature correspondingly ranges from about 55° C. to about 170° C. The COC thus is glassy at room temperature and remains glassy at temperatures significantly above room temperature. The glass transition temperature of the COC is substantially higher than that of the polypropylene in the composition.

### BACKGROUND OF THE INVENTION

The present disclosure relates to polypropylene-based polymer compositions in which polypropylene in homopolymer, copolymer (random, block, or grafted), terpolymer, or interpolymer (consisting of one or more comonomer/comonomers) form constitutes a major weight percentage of the composition. More particularly, the disclosure relates to such a polypropylene-based composition having enhanced melt strength, without requiring any special processing such as post-reactor long chain branching or electron beam treatment.

Polypropylene compositions are used for a variety of applications in which the composition is subjected to a thermoforming or foaming operation. Applications such as these require high melt strength (also known as melt elasticity) polymer so that the sheet being thermoformed or the polymer being foamed maintains sufficient structural integrity. If the melt strength is not high enough, the sheet can tear or become excessively thin during thermoforming, or the foam cells can burst during foaming. Unfortunately, polypropylene made by conventional processes has relatively poor melt strength, and thus has a very narrow temperature window for melt processing.

Accordingly, efforts have been expended toward improving the melt strength of polypropylene using various techniques. One known technique is irradiating the polypropylene with an electron beam to form long chain branches on the polypropylene molecules. Another known technique is to form long chain branches by post-reactor long chain branching technology. Increasing the melt strength allows a wider temperature window during melt processing. However, these special processes are relatively expensive. An alternative for enhancing the melt strength of polypropylene would be beneficial.

### BRIEF SUMMARY OF THE DISCLOSURE

In accordance with the present disclosure, the melt strength of polypropylene is enhanced by blending a cyclo-olefin copolymer (COC) into the polypropylene. A polypropylene-based composition of enhanced melt strength in one embodiment comprises a blend of polypropylene comprising at least 50% by weight of the composition, and cyclo-olefin copolymer comprising an amorphous random copolymer of ethylene and norbomene, the cyclo-olefin copolymer comprising at least 60 wt. % of norbomene. Cyclo-olefin copolymers are known in the industry as COC and COP.

As a result of the high norbomene content of the COC, the glass transition temperature of the COC is relatively high. In preferred embodiments, the norbomene content ranges from about 60 wt. % to about 85 wt. %, and the glass transition temperature correspondingly ranges from about 55° C. to about 170° C. The COC thus is glassy at room temperature and remains glassy at temperatures significantly above room temperature. The glass transition temperature of the COC is substantially higher than that of the polypropylene in the composition.

In preferred embodiments, the COC comprises from about 1 wt. % to about 25 wt. %, more particularly from about 5 wt. % to about 20 wt. %, of the composition.

The polypropylene that makes up the majority of the composition can comprise polypropylene homopolymer, copolymer, terpolymer, or interpolymer. As one example, the composition can include a block copolymer of polypropylene with ethylene-containing blocks. The ethylene-containing blocks can comprise ethylene-propylene rubber, for example. Other ethylene-containing blocks that can be used include polyethylene homopolymer, polyethylene copolymer, terpolymer and interpolymers consisting of one or more additional co-monomers with alpha substituted olefins and unsaturated olefin monomer, low molecular weight olefin olegomers, waxes, and elastomeric homo- and co-polymers thereof. The blocks may also contain short chain branches of ethylene or alpha olefin and substituted olefin molecules, including unsaturations. These examples are merely illustrative and not limiting.

A further aspect of the present disclosure is a method for enhancing the melt strength of polypropylene without requiring special processes such as post-reactor long chain branching. The method comprises the steps of providing a quantity of polypropylene, and blending into the polypropylene a quantity of cyclo-olefin copolymer (COC) comprising an amorphous random copolymer of ethylene and norbomene, the cyclo-olefin copolymer comprising at least 60 wt. % of norbornene.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a graph showing the glass transition temperature as a function of the weight percentage of norbornene in a random copolymer of ethylene and norbomene, which is useful for enhancing the melt strength of polypropylene in accordance with one embodiment of the invention;

FIG. 2 is a graph of specific extruder screw amperage (ratio of screw amperage to material flow rate) versus the weight percentage of COC additive in various polypropylene-based compositions made in accordance with embodiments of the invention;

FIG. 3 is a graph of die pressure versus the weight percentage of COC additive in the polypropylene-based compositions of FIG. 2; and

FIG. 4 is a graph of storage modulus versus temperature for films made from the polypropylene-based compositions of FIGS. 2 and 3.

### DETAILED DESCRIPTION OF PARTICULAR EMBODIMENTS

The present invention now will be described more fully hereinafter with reference to the accompanying drawings. The invention may be embodied in many different forms and should not be construed as limited to the embodiments set forth herein; rather, these embodiments are provided so that this disclosure will satisfy applicable legal requirements. Like numbers refer to like elements throughout.

As noted, a well-known characteristic of conventional polypropylene is its low melt strength (also referred to as “melt elasticity”). The melt strength of a polymer composition is a measure of the extensional viscosity of the composition in a molten state; thus, the higher the extensional viscosity, the higher the melt strength. Melt index is usually measured using a test procedure such as the ASTM D 1238 standard test method, and is expressed in units of grams per 10 minutes. The melt index of polypropylene is measured at a standard temperature of 230° C. Melt index as measured by ASTM D 1238 is not a measure of melt strength. However, the storage modulus values, as measured by a dynamic mechanical thermal analyzer, can be used to compare the melt elasticity of various polymers. The higher is the storage modulus value above the melting point, the higher is the melt elasticity.

Conventional polypropylene typically has a melt index ranging from about 2 g/10 minutes up to as high as 50 g/10 minutes. By “conventional polypropylene” is meant polypropylene that has not been specially processed to create long chain branches, such as by post-reactor long chain branching technology or electron beam irradiation. The relatively high melt index and low melt strength of conventional polypropylene in some applications can make this polymer unsuitable for certain type of melt processing. For example, when thermoforming a polymer sheet, low melt strength results in excessive sag of the sheet, and can even lead to rupture or excessive thinning of the sheet at locations where the sheet is subjected to the highest tensile forces. As another example, foaming of a polymer melt requires sufficient melt strength to avoid rupture of the bubbles formed in the polymer; conventional polypropylene is prone to such rupture because of its low melt strength.

It would be beneficial to be able to use polypropylene in thermoforming and foaming applications because of the other advantageous properties that polypropylene possesses, such as its relatively high tensile strength below its melting point. Conventional polypropylene can be used in such applications only if the melt state processing temperature is very precisely regulated to a level low enough to maintain adequate melt strength but high enough to keep the polypropylene in the formable state. The acceptable “processing temperature window” of conventional polypropylene is very narrow, however, and thus it is difficult in practice to control the temperature closely enough to stay within the window. For these reasons, the use of polypropylene in thermoforming and foaming applications is often avoided, in favor of other polymers of higher melt strength.

In accordance with the present invention, the melt strength of polypropylene is enhanced not by special processing to form long chain branches, but instead by melt blending the polypropylene with a second polyolefinic component having partial compatibility with some of the components of polypropylene and having a higher glass transition temperature than the polypropylene. Accordingly, the second polyolefinic component acts as long chain branches at the melt state processing temperature. As a result, the acceptable temperature window is significantly widened.

More particularly, in accordance with one embodiment, a polypropylene-based composition is formed by blending polypropylene with a cyclo-olefin copolymer (COC) comprising an amorphous random copolymer of ethylene and norbomene. Norbomene is made by the Diels-Alder reaction of cyclopentadiene and ethylene. It is a bicyclo-olefin comprising a bridged six-membered ring with a double bond on one side, and is a colorless substance with a melting point of about 46° C. (115° F.). The structure of norbomene makes it highly reactive such that the basic norbornene molecule can be readily modified or incorporated into larger molecules such as COC.

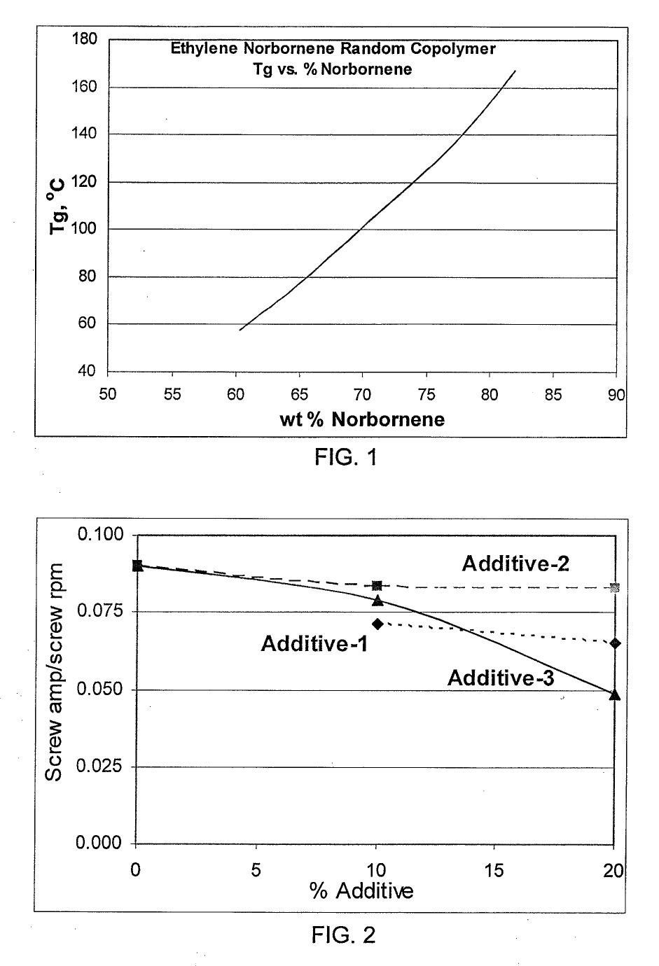

As shown in FIG. 1, the glass transition temperature of a random copolymer of ethylene and norbornene is a function of the weight percentage of norbornene in the copolymer. Specifically, at a norbornene content of 60 wt. %, the glass transition temperature (T_{g}) for this particular copolymer is about 55° C. The glass transition temperature increases nearly linearly with increasing norbornene content, and at a norbornene content of 85 wt. %, the glass transition temperature is approximately 170° C. Over the range of about 60 wt. % to about 85 wt. % of norbornene, the glass transition temperature of the COC is substantially higher than room temperature.

Thus, the glass transition temperature of the COC is substantially higher than that of the polypropylene in the composition. In this regard, atactic polypropylene typically has a T_{g} of about −20° C., and isotactic polypropylene typically has a T_{g} of about 0° C.

In accordance with the invention, by selecting the norbornene content of the COC and the proportion of the COC used in the polypropylene-based composition, the melt strength of the composition can be tailored to the desired level.

A number of trials were run to assess the effects of particular COC formulations and the proportion of COC on the characteristics of the resulting polymer blends. Three different COC additives were employed, and their pertinent properties are listed in the following table:

| | | Melt | Tensile | Flex. | | |
|---|---|---|---|---|---|---|
| | | Index¹ | Mod. | Mod. | T_{g}² | HDT³ |
| | % NB | g/10 min. | kpsi | kpsi | ° C. | ° C. |
| Additive 1 | 76 | 9 | 460 | 500 | 136 | 130 |
| Additive 2 | 76 | 1 | 420 | 500 | 136 | 130 |
| Additive 3 | 79 | 4 | 435 | 500 | 159 | 150 |

¹ASTM D 1238
²ASTM E 1356
³Heat Deflection Temperature, per ISO 75-1 and -2

Each of these additives was melt blended in 10 wt. % and 20 wt. % proportions with a polypropylene impact copolymer (PP-ICP) comprising a block copolymer of polypropylene with polyethylene macromolecular blocks. The PP-ICP had a melt index of about 1 g/10 minutes, a tensile strength of 3.7 ksi, a flexural modulus of 185 ksi, a heat deflection temperature of 91° C., a shore hardness of R80, a room-temperature notched impact strength of N/B (no break), and a notched impact strength of 60 J/m at −30° C. A total of seven compositions (two for each of Additives 1, 2, and 3, plus pure PP-ICP) were made and tested. Each of the compositions was extruded through a single-screw extruder equipped with a gear pump, static mixer, and sheet die. The extrusion rate was 24 lb/hr. The die opening was adjusted to produce 30 mil thick sheets. A three-roll stacked chill roll was used for casting and sizing the films. For all of the compositions, the melt temperature at the die was 240° C. and the set temperatures of the chill rolls were 87° C., 80° C., and 75° C.

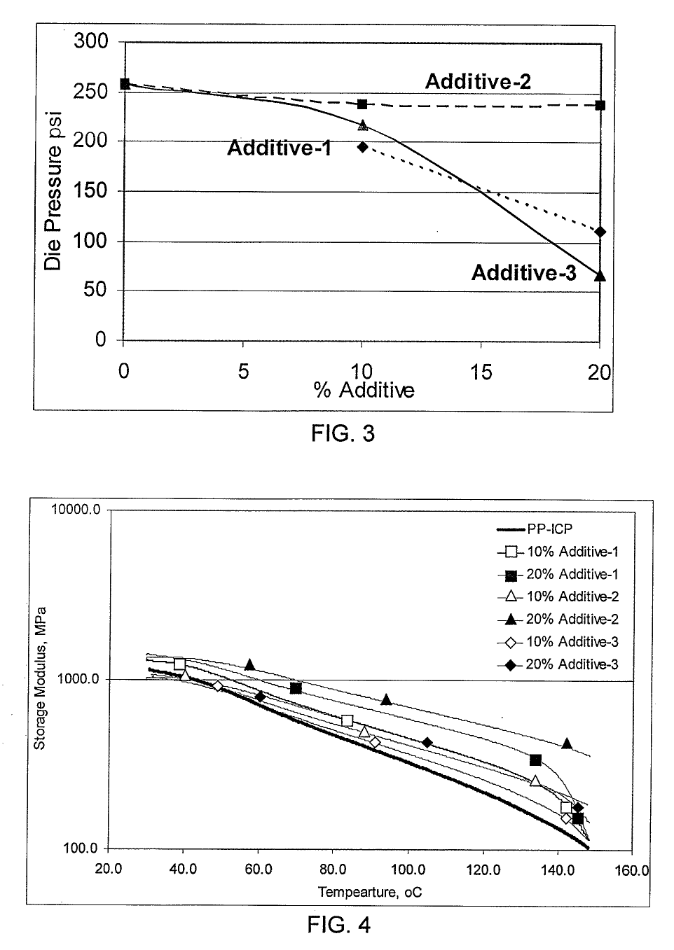

FIG. 2 shows the extruder screw amperage per rpm, plotted versus the weight percentage of the COC additive in the compositions. FIG. 3 shows the die pressure versus weight percentage of COC. From these results, it can be seen that the compositions employing Additive 2 behaved in a substantially similar manner to the pure PP-ICP.

Each of the films was tested on a mechanical spectrometer to measure the storage modulus as a function of temperature. The storage modulus and loss modulus in a viscoelastic material respectively quantify the stored energy, representing the elastic portion, and the energy dissipated as heat, representing the viscous portion, when the material is deformed. The spectrometer applies a periodic deformation at a known frequency to the test specimen and measures the delay 6 between the applied stress and the resulting strain. Based on the measured 6 and other known quantities, the storage modulus can be calculated. In general, a higher storage modulus at high temperature is advantageous for applications in which higher melt strength is beneficial, because such higher storage modulus suggests that the composition will have a greater degree of elasticity at melt processing temperatures.

FIG. 4 shows the storage modulus values for the seven different films, plotted versus temperature. From the plot, it can be concluded that the storage modulus at elevated temperature can be significantly increased by addition of COC to the PP-ICP. Additive 2 was found to be the best in terms of the amount of storage modulus increase. Based on these test results, it is apparent that significant improvement in melt strength of a conventional polypropylene can be realized by addition of a suitably selected amorphous random copolymer of ethylene and norbomene, wherein the copolymer comprises at least about 60 wt. % of norbomene. Commercially available COC grades have norbornene contents as high as about 82 wt. %. Suitable COC resins that can be employed in the polypropylene-based compositions described herein include the various TOPAS® COC resins available from Topas Advanced Polymers, Inc., the various APEL® COC resins available from Mitsui Chemicals America, Inc, and Xeonex or Zeonor from Zeon Corporation.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A polypropylene-based composition of enhanced melt strength, the composition comprising a blend of:
polypropylene comprising a major fraction of the composition by weight; and
cyclo-olefin copolymer comprising an amorphous random copolymer of ethylene and norbornene, the cyclo-olefin copolymer comprising at least about 60 wt. % of norbornene.

2. The polypropylene-based composition of claim 1, wherein the cyclo-olefin copolymer comprises between about 60 wt. % and 85 wt. % of norbomene.

3. The polypropylene-based composition of claim 1, wherein the cyclo-olefin copolymer comprises from about 1 wt. % to about 25 wt. % of the composition.

4. The polypropylene-based composition of claim 1, wherein the cyclo-olefin copolymer comprises from about 5 wt. % to about 15 wt. % of the composition.

5. The polypropylene-based composition of claim 1, wherein the polypropylene comprises polypropylene homopolymer.

6. The polypropylene-based composition of claim 1, wherein the polypropylene comprises a polypropylene copolymer, terpolymer, or interpolymer.

7. The polypropylene-based composition of claim 1, wherein the polypropylene comprises a block copolymer of polypropylene with ethylene-containing blocks.

8. The polypropylene-based composition of claim 7, wherein the ethylene-containing blocks comprise polyethylene.

9. The polypropylene-based composition of claim 1, wherein the cyclo-olefin copolymer has a glass transition temperature from about 55° C. to about 170° C.

10. The polypropylene-based composition of claim 9, wherein the melting point temperature of the polypropylene is about 165° C.

11. The polypropylene-based composition of claim 10, wherein the glass transition temperature of the cyclo-olefin copolymer is about 130° C. to 170° C.

12. A method for enhancing the melt strength of polypropylene, comprising the steps of:
providing a quantity of polypropylene; and
blending into the polypropylene a quantity of cyclo-olefin copolymer comprising an amorphous random copolymer of ethylene and norbomene, the cyclo-olefin copolymer comprising at least 60 wt. % of norbornene.

13. The method of claim 12, wherein the blending step is carried out such that the cyclo-olefin copolymer comprises from about 1 wt. % to about 25 wt. % of the composition.

14. The method of claim 12, wherein the blending step is carried out such that the cyclo-olefin copolymer comprises from about 5 wt. % to about 15 wt. % of the composition.
